(19) United States
(12) Patent Application Publication
(10) Pub. No.: US 2012/0215492 A1
(43) Pub. Date: Aug. 23, 2012

(54) Methods & apparatus for remotely diagnosing grid-based computing systems

(76) Inventor: Vijay Masurkar, Chelmsford, MA (US)

(21) Appl. No.: 10/875,329

(22) Filed: Jun. 24, 2004

(51) Int. Cl. G06F 15/00; G06F 11/32

(52) U.S. Cl. 702/185

(57) ABSTRACT

A method, apparatus and computer program product for remotely diagnosing grid-based computing systems includes establishing an event framework defining an arrangement of event information, receiving a diagnostic event record from a resource within the grid-based computing system, the diagnostic event record containing event data concerning an event that has occurred within the resource in the grid, and diagnostic telemetry information concerning operation of the resource up to the occurrence of the event. The diagnostic event record is applied to the event framework to identify at least one resource causing the occurrence of the event in the grid-based computing system. Specific identities of resources impacted by the event are presented to the user via a graphical user interface.

### BACKGROUND

Grid-based computing utilizes system software, middleware, and networking technologies to combine independent computers and subsystems into a logically unified system. Grid-based computing systems are composed of computer systems and subsystems that are interconnected by a standard technology such as networking, I/O, or web interfaces. The grid-based computing system is managed as a single computing system. The grid-based computing systems are configured from computer systems that are generally managed and used both as part of the grid and as independent systems. The individual subsystems of the grid-based system are not fixed in the grid, and the overall configuration of the grid-based system may change over time. Grid-based computing system resources can be added or removed from the grid-based computing system at any time. Such changes can be-regularly scheduled events, the results of long-term planning, or virtually random occurrences. Geographic distribution of subsystems can range from interoffice to national to global. Advantages associated with grid-based computing systems include increased utilization of computing resources, cost-sharing, and improved management of system subsystems and resources.

### SUMMARY

Conventional mechanisms such as those explained above suffer from a variety of problems or deficiencies. One such problem is that conventional grid-based computing systems are difficult to diagnose when problems with the grid-based computing system occur. Typically, one or more service persons are required to go on-site to diagnose the problem. This can be time consuming, expensive, and result in extended system downtime.

Embodiments of the invention significantly overcome such deficiencies and provide mechanisms and techniques that provide remote diagnosis of a grid-based computing system. A data structure including an event framework defining an arrangement of event information is provided. A diagnostic event record is received regarding a resource within the grid-based computing system. The diagnostic event record contains event data concerning an event that has occurred within the resource in the grid and may further contain diagnostic telemetry information concerning operation of the resource up to the occurrence of the event. The diagnostic event record is applied to the event framework to identify at least one resource causing the occurrence of the event in the grid-based computing system. Multiple ways can be employed as explained in the invention to narrow down to the possible problem area. Specific identities of resources impacted by the event are presented to the user via a graphical user interface.

In a particular embodiment of a method for providing remote diagnosis of a grid-based computing system, the method begins with establishing an event framework defining an arrangement of event information. The method includes receiving a diagnostic event record regarding a resource within the grid-based computing system, the diagnostic event record containing event data concerning an event that has occurred within the resource in the grid and further containing diagnostic telemetry information concerning operation of the resource up to the occurrence of the event. The method further involves applying the diagnostic event record to the event framework to identify at least one resource causing the occurrence of the event in the grid-based computing system. The method may further incorporate presenting, via a graphical user interface, specific identities of resources impacted by the event.

Other embodiments include a computer readable medium having computer readable code thereon for providing remote diagnosis of a grid-based computing system. In a particular embodiment the computer readable code includes instructions for establishing an event framework defining an arrangement of event information. The computer readable code further includes instructions for receiving a diagnostic event record regarding a resource within the grid-based computing-system, the diagnostic event record containing event data concerning an event that has occurred within the resource in the grid and diagnostic telemetry information concerning operation of the resource up to the occurrence of the event. The computer readable code may further include instructions for applying the diagnostic event record to the event framework to identify at least one resource causing the occurrence of the event in the grid-based computing system. The computer readable code may further include instructions for presenting, via a graphical user interface, specific identities of resources impacted by the event.

Still other embodiments include a computerized device, configured to process all the method operations disclosed herein as embodiments of the invention. In such embodiments, the computerized device includes a memory system, a processor, and a communications interface in an interconnection mechanism connecting these subsystems. The memory system is encoded with a process that provides remote diagnosis of a grid-based computing system as explained herein that when performed (e.g. when executing) on the processor, operates as explained herein within the computerized device to perform all of the method embodiments and operations explained herein as embodiments of the invention. Thus any computerized device that performs or is programmed to perform up processing explained herein is an embodiment of the invention.

Other arrangements of embodiments of the invention that are disclosed herein include software programs to perform the method embodiment steps and operations summarized above and disclosed in detail below. More particularly, a computer program product is one embodiment that has a computer-readable medium including computer program logic encoded thereon that when performed in a computerized device provides associated operations providing remote diagnosis of grid-based computing systems as explained herein. The computer program logic, when executed on at least one processor with a computing system, causes the processor to perform the operations (e.g., the methods) indicated herein as embodiments of the invention. Such arrangements of the invention are typically provided as software, code and/or other data structures arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC) or as downloadable software images in one or more modules, shared libraries, etc. The software or firmware or other such configurations can be installed onto a computerized device to cause one or more processors in the computerized device to perform the techniques explained herein as embodiments of the invention. Software processes that operate in a collection of computerized devices, such as in a group of data communications devices or other entities can also provide the system of the invention. The system of the invention can be distributed between many software processes on several data communications devices, or all processes could run on a small set of dedicated computers, or on one computer alone.

It is to be understood that the embodiments of the invention can be embodied strictly as a software program, as software and hardware, or as hardware and/or circuitry alone, such as within a data communications device. The features of the invention, as explained herein, may be employed in data communications devices and/or software systems for such devices such as those manufactured by Sun Microsystems, Inc. of Santa Clara, Calif.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a diagram of a prior art grid-based computing system;

FIG. 2 is a block diagram of a particular embodiment of an architecture for remotely diagnosing grid-based computing systems;

FIG. 3 is a tree diagram of a particular framework for grid-based events;

FIG. 4 is a diagram of a sample screen for selecting a company;

FIG. 5 is a diagram of a sample screen for selecting a grid-based computing system within a company;

FIG. 6A is a diagram of a sample screen for selecting a farm within a selected grid-based computing system;

FIG. 6B is a diagram of a screen to immediately see a set of events and alarms pointing and clicking on a farm;

FIG. 7 is a diagram of a sample screen for selecting a resource within a selected farm;

FIG. 8 is a diagram of a sample screen showing devices within a selected resource; and

FIGS. 9A and 9B are a flow diagram of a particular embodiment of a method for remotely diagnosing grid-based computing systems.

### DETAILED DESCRIPTION

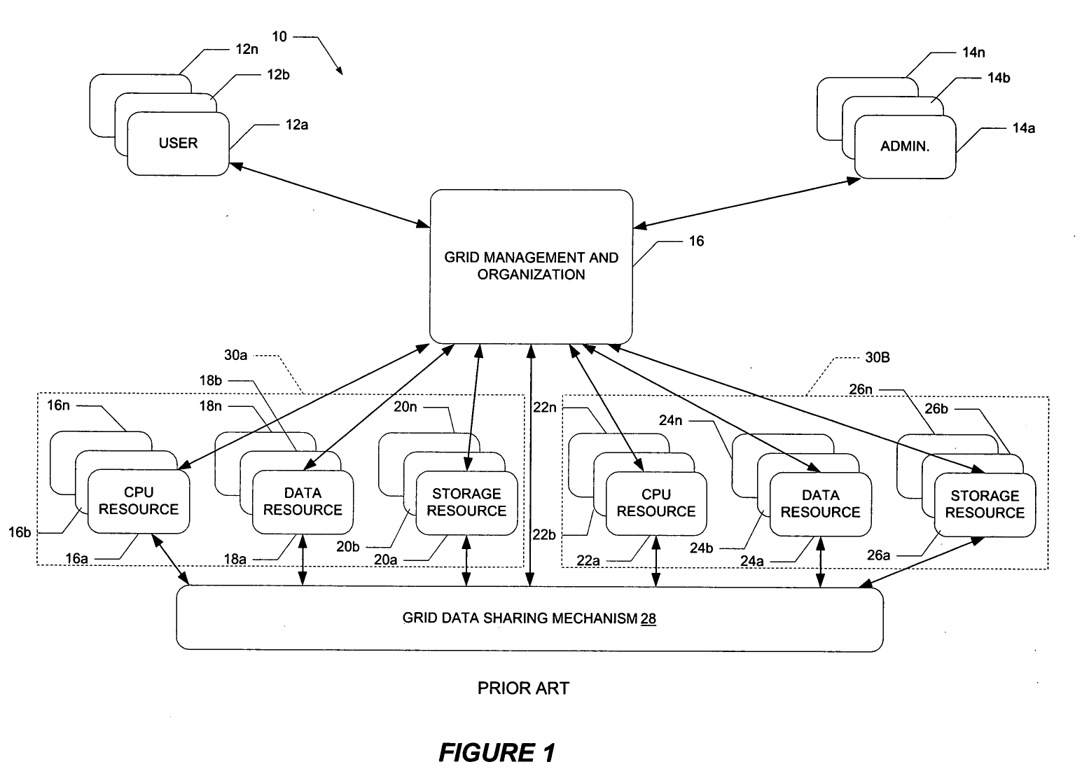

Referring to FIG. 1, a prior art grid-based computing system 10 is shown. The grid-based computing system 10 may include one or more users 12a-12n and one more administrators 14a-14n. A grid management and organization element 16 is in communication with users 12a-12n and with administrators 14a-14n. Also in communication with the grid management and organization element 16 is a first set of CPU resources 16a-16n, a first set of data resources 18a-18n and a first set of storage resources 20a-20n. The first set of CPU resources 16a-16n, data resources 18a-18n, and storage resources 20a-20n may be collectively referred to as a farm 30a. A CPU resource could comprise a personal computer, a mainframe computer, a workstation or other similar type device. A data resource may be a database, a data structure or the like. A storage resource may include magnetic tape storage, semiconductor storage, a hard drive device, a CD-ROM, a DVD-ROM, a computer diskette, or similar type device.

Grid management and organization element 16 is also in communication with a second set of CPU resources 22a-22n, a second set of data resources 24a-24n, and a second set of storage resources 26a-26n. The second set of CPU resources 22a-22n, second set of data resources 24a-24n, and second set of storage resources 26a-26n may comprise farm 30b. While two farms 30a and 30b are shown, it should be appreciated that any number of farms could be included in the grid-based computing system 10. Further, while CPU resources, data resources and storage resources are shown, other resources, including but not limited to servers, network switches, firewalls and the like could also be utilized.

A grid data sharing mechanism 28 is in communication with the grid management organization elements 16 as well as the first set of CPU resources 16a-16n, data resources 18a-18n, and storage resources 20a-20b. The grid data sharing mechanism 28 is also in communication with the second set of CPU resources 22a-22b, data resources 24a-24b and storage resources 26a-26b. Additional resources and resource types may be added to a farm from a resource pool, and resources may also be subtracted from a farm which may go back into the resource pool. With such an arrangement, a user (e.g., user 12b) can access a CPU resource (e.g. CPU resource 22a) in farm 30a, while also utilizing data resource 24b and storage resource 26n. Similarly, an administrator 14a can utilize CPU resource 16n and storage resource 20a. Grid management and organization element 16 and grid data sharing mechanism 28 control access to the different resources as well as managing the resources within the grid based computing system 10.

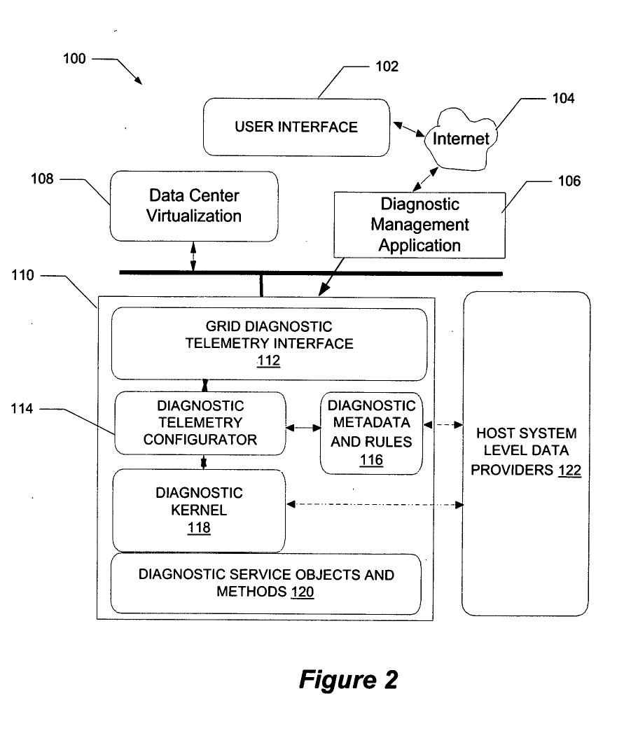

Referring now to FIG. 2, an architecture 100 useful for providing remote diagnosis of a grid-based computing system, such as the grid-based computing system described in FIG. 1, is shown. A user interface 102 (also referred to as a front-end) is accessed by a user. The user interface 102 provides communication across a network, e.g., Internet 104, to access a diagnostic management application 106 which is resident on the grid-based computing system. The user interface 102 allows a user in one location to communicate with any number of grid-based computing systems located remotely from the user. The user interface provides a user (such as a service engineer) the ability to focus in on a customer's location, a customer's grid-based computing system and the associated event framework to receive and review relevant events, alarms and telemetry information. The user interface further allows the user to select the primary grid-based computing system entities, such as farm, resource or a subsystem within a farm or resource for examination. The user interface displays trouble areas, displaying events that are critical and others as necessary.

Using the interface, the user is able to collect information from the grid-based computing system pertaining to server farm and resource level events and error conditions, configuration information and changes, utility reports at farm and resource levels, and asset survey and asset delta (i.e. change) reports.

The diagnostic management application 106 functions as a web server and provides information to the user interface 102 from the grid based computing system.

The Data Center Virtualization software 108 is also resident in the grid-based computing system. The Data Center Virtualization software 108 is used to manage the grid-based computing system as a single system, instead of as a collection of individual systems. The Data Center Virtualization element 108 is in communication with a grid diagnostic core 110, which includes a Grid Diagnostic Telemetry Interface 112, a Diagnostic Telemetry Configurator 114, a Diagnostic Metadata and Rules database 116, a Diagnostic Kernel 118, and a Diagnostic Service Objects and Methods software library 120. Diagnostic Kernel 118 is used to facilitate the fault management at the individual nodes or resources within the grid-based computing system.

The Grid Diagnostic Telemetry Interface 112 is in communication with the Diagnostic Telemetry Configurator 114, and is used to provide grid related data to the Data Center Virtualization element 108.

The Diagnostic Telemetry Configurator 114 is in communication with the Diagnostic Metadata element 116 and with the Diagnostic Kernel 118. The Diagnostic Telemetry Configurator 114 is used to provide metadata parameters to Data Providers 122, and parameters and rules to Diagnostic Kernel 118. These parameters are part of databases or database files populated by the user through the user interface 102.

The Diagnostic Metadata and Rules element 116 is in communication with Data Providers 122, and is used by an administrator to configure telemetry parameters (based on the diagnostic metadata) such as thresholds that in turn enable alarms when the thresholds are crossed.

The Diagnostic Kernel 118 is linked with the Diagnostic Service Objects and Methods software library 120, and is used to launch diagnostic service instances that receive relevant information from Data Providers 122. A diagnostic service instance started by the Diagnostic Kernel 118 provides multiple functions. A first function provided by the Diagnostic Kernel 118 is to address the fault and provide a derived list of suspect causes, leading to a subsystem fault—either at the grid-based computing system farm-resource-control layer or at the host subsystem level. The control layer provides control and management of resource-pool devices. The Diagnostic Kernel 118 further initiates a service instance via Diagnostic Service Objects and Methods element 120 to remediate the faulted condition. The Diagnostic Kernel 118 also sends diagnostic telemetry information via the grid Diagnostic Telemetry Interface 112 to the user interface 102.

Data Providers 122 supply data from host systems (also referred to as resources in the grid-based computing system) for resolving problems at the host level. Data Providers 122 may include, but are not limited to, one or more of a system statistics provider, a hardware alarm provider, a trend provider, a configuration provider, an FRU—(Field Replaceable Unit) information provider, a system analysis provider, a network storage provider, a configuration change provider, and a reboot provider. These data providers 122 supply relevant information into the service instances initiated by the Diagnostic Kernel 118. Data Providers 122 may also utilize metadata whose parameters are configured by administrators utilizing the user interface 102 via the Diagnostic Telemetry Configurator 114.

The present method and apparatus for remotely diagnosing grid-based computing systems provides a service interface to the customer's grid-based computing system environment, the ability to examine entities within those computing systems, and the ability to initiate automated procedures (using diagnostic metadata and rules) or collect diagnostic related data for analysis and resolution of the problem.

The remote diagnosis abilities focus on being able to remotely identify problems by deploying method and apparatus that identify causes for problems, and, in certain instances, to automatically resolve the problem.

The service engineer can further invoke a utility to allow the service engineer to remotely execute commands in the customer's grid environment and to remotely examine behavior of a web service (consisting of several related applications) or of a single application running in the grid environment; both sharing the execution view and control with users (customers) who own the application environment within the grid.

Information at the time of failure of any entity is particularly helpful for troubleshooting purposes. In conventional operation of a grid-based computing system, upon an indication of failure, a failed device in the resource pool is replaced with another available device. However, all of the failure information may not be saved. Therefore, in a particular embodiment of remotely diagnosing a grid-based computing system, when a device fails, the failure details are exported to the grid-diagnostic core 110.

In a particular embodiment, there are two types of events that are watched for customers. One type of event is termed a “chargeable” event. These chargeable events are primarily intended for use by the grid-based computing system for billing their end users for usage.

Another type of event that services personnel are also interested in monitoring and processing are events that represent failures in the grid-based computing system for customers. For example, a device fails and is replaced by another device automatically which satisfies the Service Level Agreement (SLA) requirements for the end user. A typical self-healing architecture is expected to recover from such a failure. However, it may be necessary to examine the device that exhibited failure symptoms. Additionally, it may be preferable to diagnose and identify the root cause of the failure in the device, to fix the device remotely and to return the device back to the grid-based computing system's resource pool.

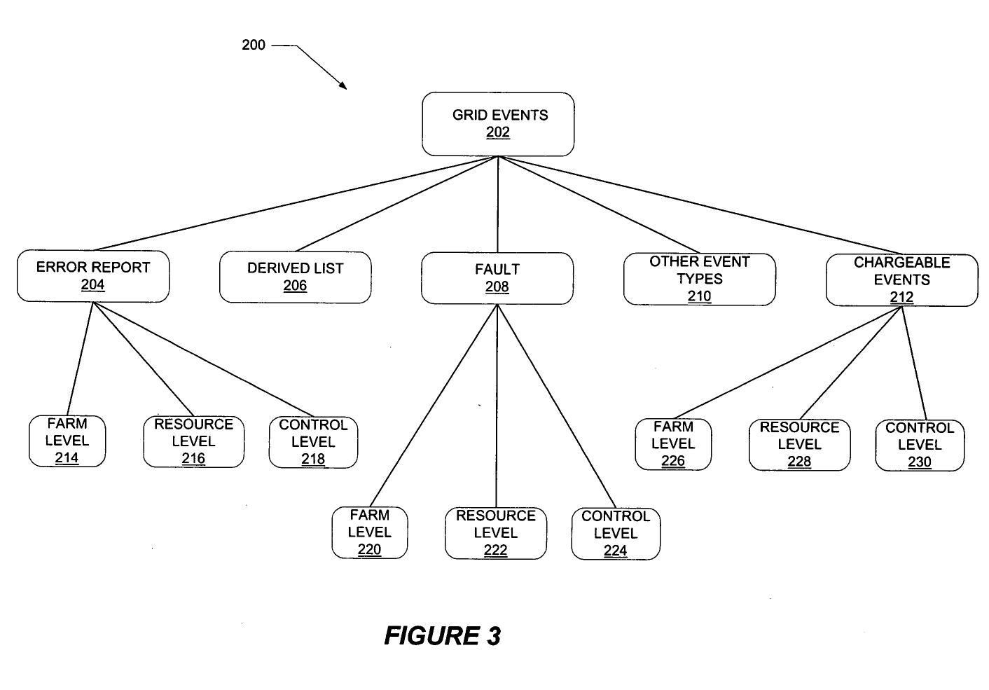

Referring now to FIG. 3, a grid event framework 200 is shown. The framework includes a top-level block (also referred to as a root node) 202 labeled grid events. The grid events can include different event types. These event types include an error report 204, a derived list 206, a fault 208, other event types 210, and chargeable events 212.

Error reports 204 (also referred to as error events) are generated upon the detection of an abnormal or unexpected condition, and are recorded in persistent storage (e.g. a file system).

Derived list 206 show one or more suspected failed devices and may also indicate a likelihood value that the device is the reason for the indicated alarm or event.

A Fault event 208 is an imperfect condition that may or may not cause a visible error condition. A fault may not actually cause an unintended behavior; for example, a sudden drop in performance of a segment of a computing system covered by a specific set of virtual local area networks (VLANs) could result in an error message. Fault management is the detection, diagnosis and correction of faults in a way to effectively eliminate unintended behavior and remediate the underlying fault.

Other event types 210 refer to events which are not an error report, derived list, fault or chargeable event. Chargeable events type 212 are described above.

Each of the event types error report 204, fault 208, and chargeable 212 may further include three sub-types: farm level, resource level and control level. The events may be segregated in these categories and may further include sub-categories in terms of their criticality level (e.g., critical, non-critical, and warning) for presentation via the diagnostic telemetry interface to the user interface.

In a particular embodiment, the chargeable events are tracked at the farm level and at the resource pool level. Chargeable event messages include: an event time, an event sequence number, and details of the event. Three primary farm level events are monitored and include: when the farm is created, when the farm is deactivated and when the farm is dysfunctional.

Resource pool events are shown in table 1 below:

TABLE 1

| Device | |
|---|---|
| Event | Definition |
| add | When a device (such as a server) is allocated |
| avail | When a device is made available for usage; for example, a |
| | server allocated and brought online in the resource pool |
| fail | When a device fails; e.g., a switch stopped forwarding data |
| | packets |
| del | When a device is deallocated; e.g. a directory server brought |
| | down for hardware maintenance |
| add and | When a device is restored; e.g. a firewall is reactivated and it |
| avail | has started filtering network traffic |

Examples of devices can include, but are not limited to, load balancers, firewalls, servers, network attached storage (NAS), and Ethernet ports. Other resources to be monitored include, but are not limited to, disks, VLANs, subnets, and IP Addresses.

A service engineer is able to associate a resource pool event with a farm event through the user interface, since each farm level event detail has a farm ID included in it and the resource level event also has an associated farm ID. For example, if a service engineer is trying to investigate a firewall failure event, the farm ID for that failed firewall device can be traced to the farm level events for that ID. Further, all the farm events for that farm can be examined to see if any one of them could have a possible relation to the failure of that specific firewall. Next, FML (Farm Markup Language), WML (Wiring Markup Language) and MML (Monitoring Markup Language) can help in the configuration and physical connectivity analysis respectively.

In the grid-based computing environment, events refer to the resource layer (rl), the control layer (cl), or the farm-level (fl). In a particular embodiment, event messages (also referred to as event records) have a common format. The event messages include the time, a sequence number and details of the event. An example is shown below in Extended Backus Nauer Form (EBNF)

```
  <event-message>::= <utc-date-time> “,” <sequence-info> “,”
<event-info> “,” <event-details>
  <event-info>::= “event” “=” <event>
  <event>::= “resource” | “control” | “farm”
  <event-details>::= <rl-event-desc>| <cl-event-desc> | <fl-event-desc>
```

Events have a sequence number that uniquely identifies the event within a given fabric. The definition of a sequence is as follows (in EBNF):
<sequence-info>::=“seq” “=” <fabric-name>“:” <sequence-id>

The event record is applied to the event framework (described above and shown in FIG. 3) to identify one or more resources which caused the event in the grid-based computing system.

There may be two types of monitoring being performed. The data providers primarily accomplish monitoring at the host level. However, the grid level monitoring is performed by a monitoring system of the grid-based computing system itself.

The monitoring system of the grid-based computing system performs several roles. The roles may include monitoring the health of equipment in the resource layer, monitoring the health of equipment in the control layer, providing a mechanism to deliver event logging throughout the ID, and providing a mechanism to deliver event logging to a third party Network Management System (NMS).

Service engineers, in certain scenarios, may need to be able to execute commands for testing or deployment purposes during or immediately after the troubleshooting process. Three access modes are desired; FullAccess, NoExecAccess and ViewAccess. FullAccess mode allows a support person to execute grid related infrastructure commands that s/he enters for which the person will need to assume the role of an “Initiator”. NoExecAccess mode allows the service engineer to enter and execute commands upon customer approval. View access mode allows the service engineer and customer to view command, and the commands are executed by the customer.

A service engineer, faced with a troubleshooting task, needs to understand the high level abstract view presented by the grid-based computing system and its allocation/deallocation/reallocation and other provisioning abilities, as well as be able to drill down to collect information from a single resource level such as a server or a network switch.

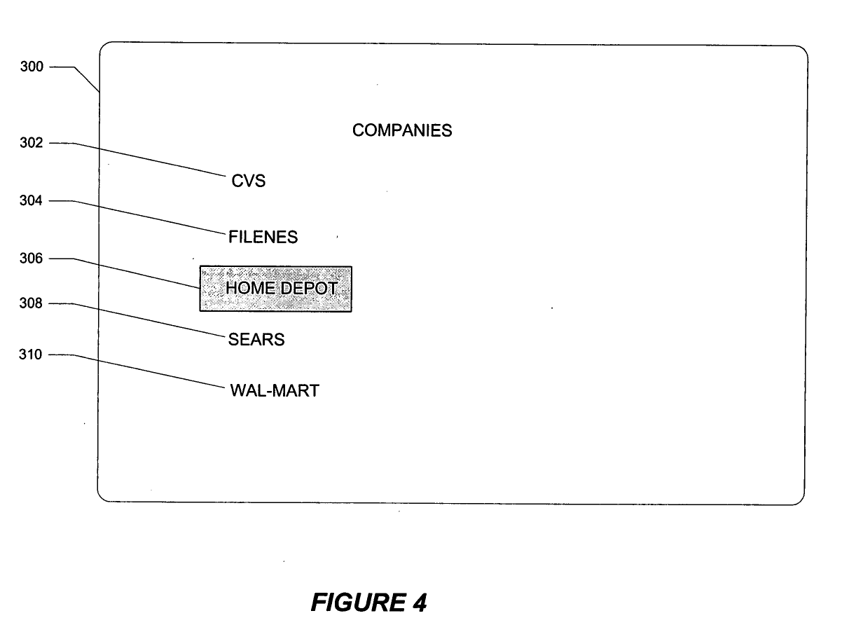

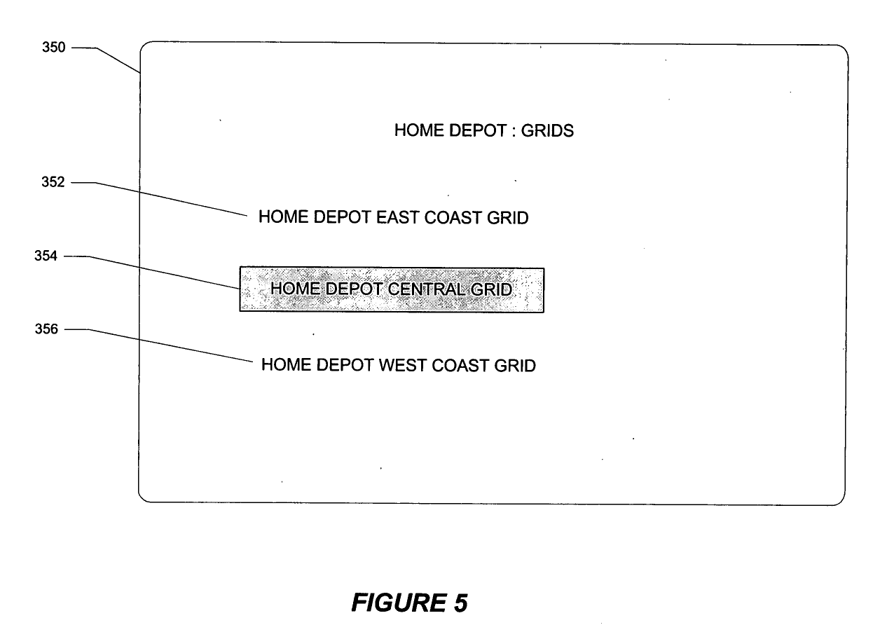

The diagrams in FIGS. 4-8 are provided in a very basic format for explanation purposes, and it should be understood that an actual screen might include additional features and provide additional functions. Referring now to FIG. 4, a diagram of a screen for selecting a company is shown. The screen 300 is used for the service engineer to select a company. In this example, a total of five companies: CVS 302, FILENES 304, HOME DEPOT 306, SEARS 308 and WAL-MART 310 are shown. While five companies are shown, it should be appreciated that any number of companies may be displayed. HOME DEPOT 306 is highlighted, indicating that an event has occurred in the HOME DEPOT grid-based computing system. The service engineer can click on the highlighted company to get to screen 350 shown in FIG. 5.

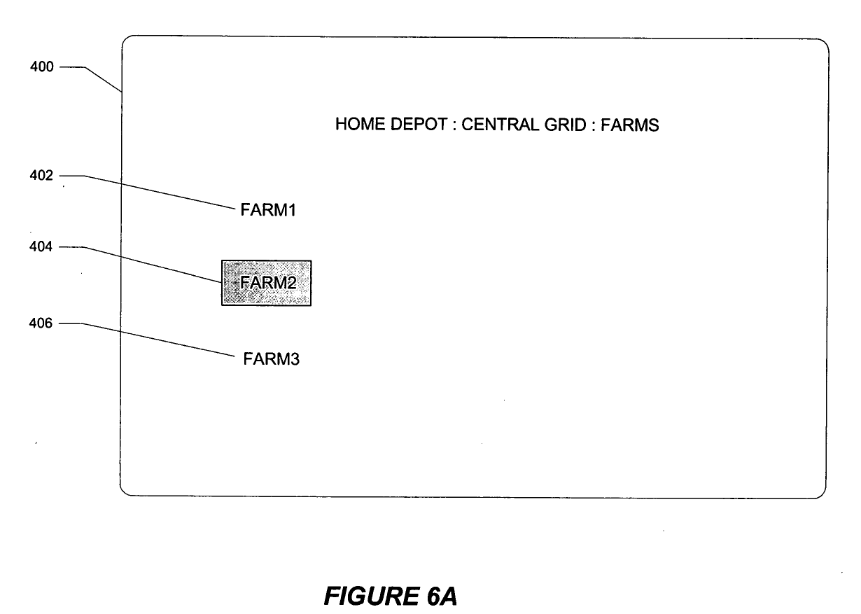

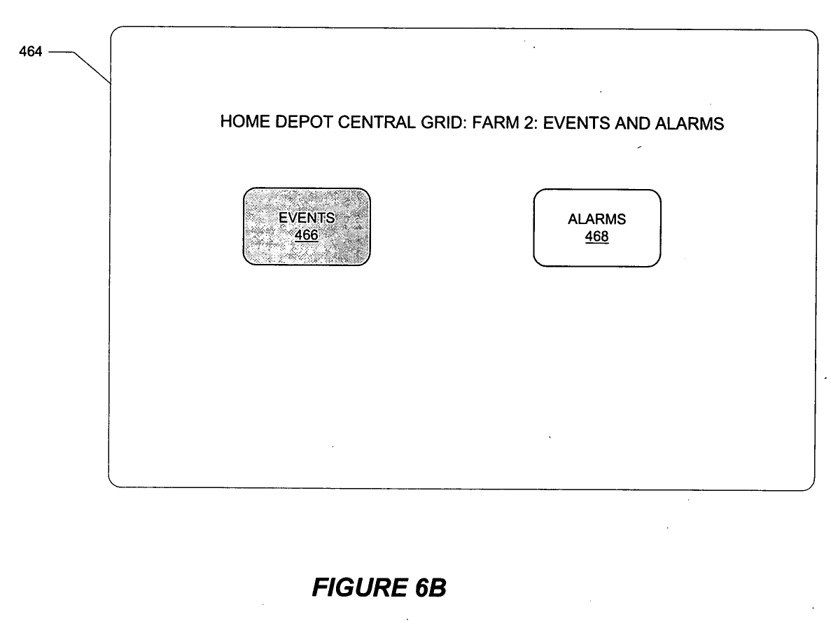

Referring now to FIG. 5, a diagram of a screen 350 titled HOME DEPOT: GRIDS is shown. This screen 350 shows a HOME DEPOT EAST COAST GRID 352, a HOME DEPOT, CENTRAL GRID 354, and a HOME DEPOT WEST COAST GRID 356. While three grids are shown, it should be appreciated that a company may include any number of grids and that any number of grids may be displayed. The HOME DEPOT CENTRAL GRID 352 is highlighted, indicating that an event has occurred within that grid-based computing system. A user can click on the highlighted grid to see all the events and alarms, and click to drill down further to determine the cause of the, event. When the user clicks on the highlighted grid, the user is taken to a screen showing the farms within the selected grid. An example of this is shown in FIG. 6A.

Referring now to FIG. 6A, a diagram 400 of a screen titled HOME DEPOT: CENTRAL GRID: FARMS is shown. This screen 400 includes three farms, labeled FARM1 402, FARM2 404 and FARM3 406. While three farms are shown, it should be appreciated that a grid may include any number of farms and that any number of farms may be displayed. In this example FARM2 404 is highlighted, indicating that the event is located in FARM2. Optionally, the service engineer can be provided with a screen 464 as shown in FIG. 6B. In this screen, the user is presented with an EVENT icon 466 and an ALARM icon 468. In this example the EVENT icon 466 is highlighted, indicating the occurrence of an event. The reason for the event or alarm however may not always be as well defined and may requires the service engineer to go through the farm level-by-level in order to precisely diagnose the cause of the event or alarm.

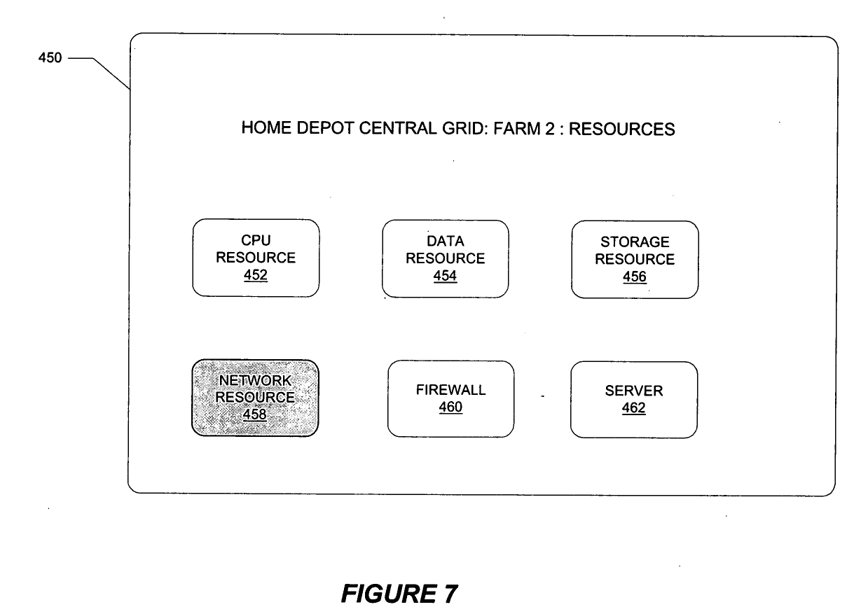

Referring back to FIG. 6A, by clicking on the highlighted farm, the user is brought to a screen showing the resources and devices included in FARM2. Such a screen is shown in FIG. 7. Optionally, a service engineer may want to immediately view events and alarms with a click on a specific farm.

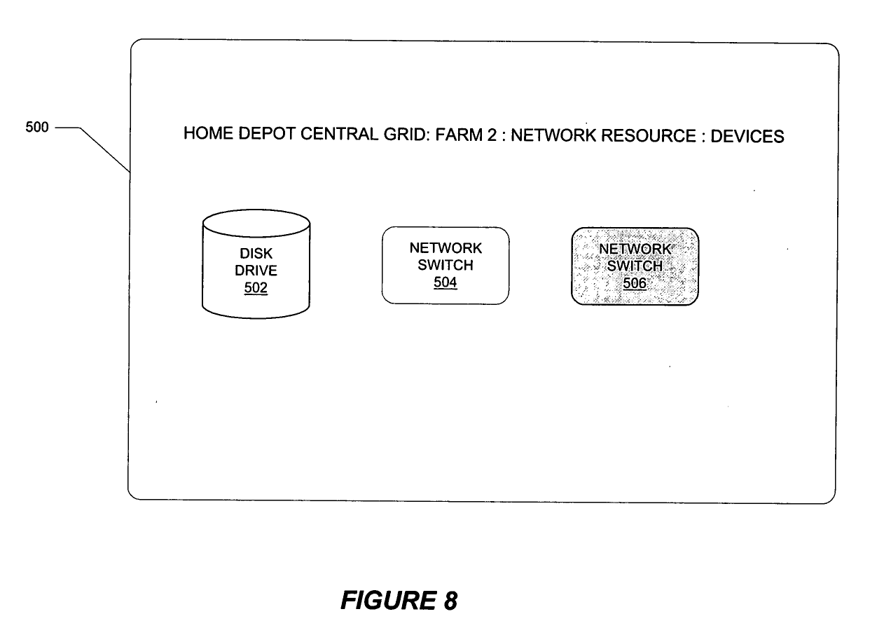

Referring now to FIG. 7, a diagram of a screen 450 labeled HOME DEPOT: CENTRAL GRID: FARM2: RESOURCES is shown. This screen 450 shows the resources belonging to FARM2. The resources include a CPU RESOURCE 452, a DATA RESOURCE 454, a STORAGE RESOURCE (which also is termed as storage subsystem) 456, a NETWORK RESOURCE 458, and devices such as a FIREWALL 460 and a SERVER 462. While a total of six resources and devices are shown, it should be appreciated that a farm may include any number of resources and devices and that any number of resources and devices could be displayed. In this example, NETWORK RESOURCE 458 is highlighted, indicating that the event is related to a network resource. By clicking on the highlighted resource, the user is brought to a screen showing the subsystems included in the selected network resource. Such a screen is shown in FIG. 8.

Referring now to FIG. 8, a diagram of a screen 500 labeled HOME DEPOT: CENTRAL GRID: FARM2: RESOURCE: DEVICES is shown. This screen 500 shows the devices or subsystems belonging to the network resource. The subsystems include a disk drive 502, a first network switch 504 and a second network switch 506. While a total of three subsystems are shown, it should be appreciated that a resource may include any number of subsystems and that any number of subsystems could be displayed. In this example, NETWORK SWITCH 506 is highlighted, indicating that the event is related to the highlighted network switch.

In a particular embodiment additional information may be shown such as the farm-resource-control layer, or device, or subsystem related telemetry data which may prove useful in performing diagnostic evaluations. Corresponding telemetry data viewing may also be enabled at the respective level of the user interface. For example, when looking at farm-resource-control layers, telemetric parameters at that level may be particularly relevant. Similarly when focused on a device, such as a directory server, telemetry data pertaining to commands such as “sar” (system activity report) or “vmstat” (virtual memory statistics) may be found to be more useful.

Diagnostic agents, also referred to herein as diagnostic service instances, may be launched on demand that are earlier configured via the diagnostic telemetry configurator (labeled 114 in FIG. 2) to run automatically to either produce a derived list of suspected areas of failed subsystems, or to isolate down to a component.

A service engineer is able to view grid-based computing system's server groups within a farm. A server group is a logical structure supported within grid-based computing systems. Server groups allow a customer to perform rapid flexing (adding/deleting capacity of a farm) of servers by associating a pre-defined role or image for all servers within that group. For example, a flexing operation could fail, and a service engineer could examine the individual physical servers and their states cross-examining FML and XML records corresponding to the farm id's for the farm in question.

Pointing to a farm, a server engineer can view all the grid-based computing system server groups, and clicking on a specific group, all the servers in that group. Clicking on resources present the devices (firewalls, servers, etc.), and other subsystems such as disks, VLANs, subnets and IP addresses.

A utility report can be generated for a selected system. Examples of information in a utility report include: percent disk usage vs. time, percent CPU utilization vs. time, percent RAM usage, vs. time, percent SWAP usage vs. time, etc. Utility reports can also be generated at the farm and resources levels. At the farm level, for example, graphical charts can be generated showing data over different time periods (e.g., over 1 day, 1 week, 1 month and 3 months). Similarly, the service engineer can generate reports at the resource level, for example, to generate graphs over different time periods that show new devices created, devices made available, devices failed, devices replaced and resource allocation/deallocation/reallocation events. Also, number of fault events that are critical, non-critical and warnings superimposed for the above different time periods for farm, resource and control level. And, chargeable events vs. time for farm and resource level.

The service engineer may also wish to view asset survey information. In a grid-based computing system the grid assets can include farms and resources; and these assets can be shown with details regarding when created, last failed, replaced and last modified. Also, deltas (changes) of assets may also be useful, the delta being for a specified time period (e.g., 1 day, 1 week, 1 month or 3 months).

The service engineer may further require information on differences between files from different time periods. The delta reports allow selections to be made by the service engineer to see differences between grid farm configuration items or any combinations of FML (Farm Markup Language) files, WML (Wiring Markup Language) files, and MML (Monitoring Markup Language) files in the form of XML-based delta configuration markup.

For example, a service engineer may want to see differences occurred between just FML and WML in the last one week, or only between MMLs from this week and three months ago. An example where this type of information is useful to a service engineer is in a scenario where a device has been identified in the troubleshooting process to have been broken down and replaced. The farm associated with the device is known because there is a farm ID associated with the device description. The service engineer can determine how that farm was configured when the device failed and what other devices were in the logical farm along with this device that communicated with it. FML information will provide the logical configuration data and WML will support it with physical connectivity information.

In addition, for detailed troubleshooting purposes, a service engineer is able to perform asset survey functions such as: on the selected farm, generate a list of server groups and servers; on the selected server, generate a list of all devices; and on the selected storage node, generate a list of all disks.

There are some configuration and properties files that a service engineer may want to watch for grid-based computing systems. For example, major breakdowns in the provisioning function could relate to unauthorized changes thus, the deltas of these files are made available.

For delta reports, changes in critical system files such as network files (e.g. /etc/nsswitch.conf) are provided. This could be in the form of a screen with a list of the files available for comparison, or a screen with a list of the specific platforms or environments that in turn will compare a pre-selected set of files. Additional files can be manually added as may be necessary.

The method and apparatus for remotely diagnosing grid-based computing systems features high availability with failover capability. Typically the system is available 24 hours a day, seven days a week. The system also features ease of use as well as ease of installation and configuration.

High security is provided when using the present method and apparatus. This is especially important when interacting with customer's system. Another factor is providing satisfactory response time for customers and service personnel.

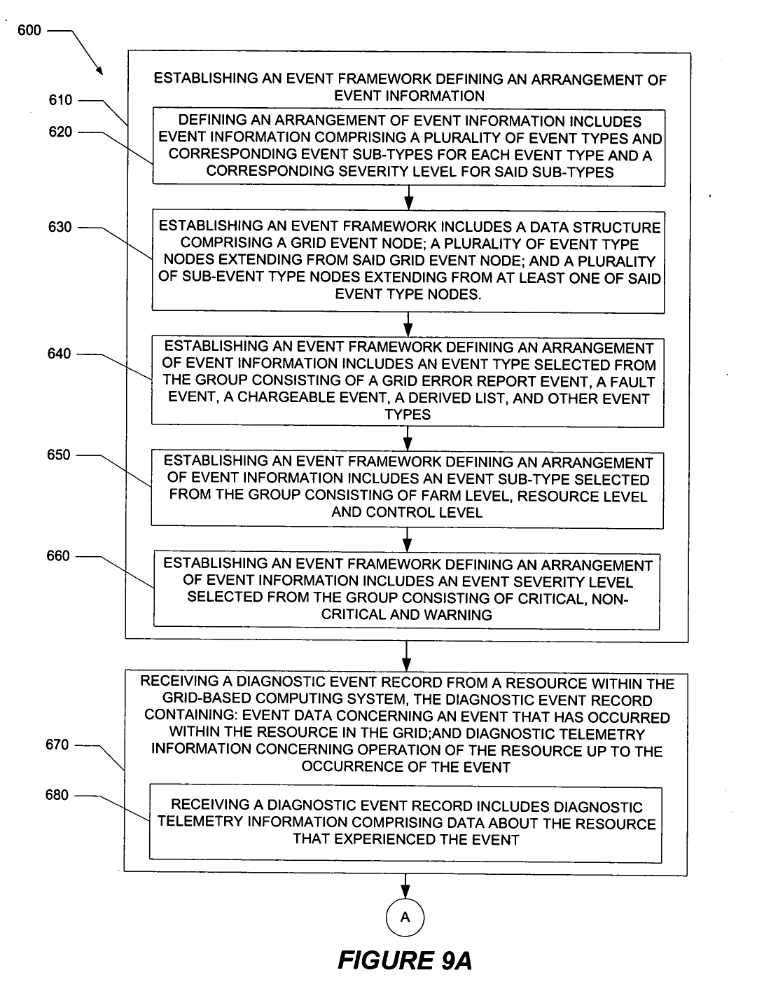

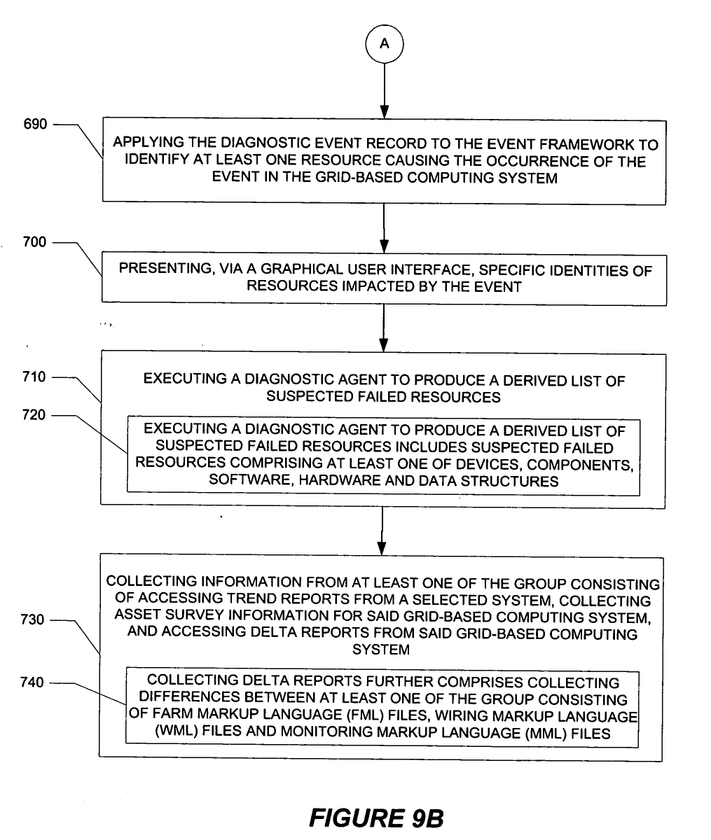

A flow chart of the presently disclosed method is depicted in FIGS. 9A and 9B. The rectangular elements are herein denoted “processing blocks” and represent computer software instructions or groups of instructions. The diamond shaped elements, are herein denoted “decision blocks,” represent computer software instructions, or groups of instructions which affect the execution of the computer software instructions represented by the processing blocks.

Alternatively, the processing and decision blocks represent steps performed by functionally equivalent circuits such as a digital signal processor circuit or an application specific integrated circuit (ASIC). The flow diagrams do not depict the syntax of any particular programming language. Rather, the flow diagrams illustrate the functional information one of ordinary skill in the art requires to fabricate circuits or to generate computer software to perform the processing required in accordance with the present invention. It should be noted that many routine program elements, such as initialization of loops and variables and the use of temporary variables are not shown. It will be appreciated by those of ordinary skill in the art that unless otherwise indicated herein, the particular sequence of steps described is illustrative only and can be varied without departing from the spirit of the invention. Thus, unless otherwise stated the steps described below are unordered meaning that, when possible, the steps can be performed in any convenient or desirable order.

Referring now to FIG. 9, a method 600 for diagnosing a grid-based computing system is shown. The method begins at processing block 610 which recites establishing an event framework defining an arrangement of event information. The event framework is useful in identifying the root cause of a detected event within the grid-based computing system.

Processing block 620 states that defining an arrangement of event information includes event information comprising a plurality of event types and corresponding event sub-types for each event type and a corresponding severity level for said sub-types. Each event may have a sub-type and each sub-type may have a severity level, wherein the severity level is used to prioritize the events.

Processing block 630 discloses that the event framework includes a data structure comprising a grid event node, a plurality of event type nodes extending from the grid event node, and a plurality of sub-event type nodes extending from at least one of the event type nodes.

Processing block 640 recites that the event framework defining an arrangement of event information includes an event type selected from the group consisting of a grid error report event, a fault event, a chargeable event, a derived list and other event types. The event is defined as one of the event types.

Processing block 650 recites establishing an event framework defining an arrangement of event information includes an event sub-type selected from the group consisting of farm level, resource level and control level. The event type is broken down into sub-types. The event can be defined as of a certain type, and of a certain sub-type within the event type.

Processing block 660 states establishing an event framework defining an arrangement of event information includes an event severity level selected from the group consisting of critical, non-critical and warning. The event sub-type can be further defined to include a severity level. The event is thus defined as being of a certain type, a certain sub-type within the event type, and of a certain severity level within the event sub-type.

Processing block 670 recites receiving a diagnostic event record from a resource within the grid-based computing system, the diagnostic event record containing event data concerning an event that has occurred within the resource in the grid. The diagnostic event record can further include diagnostic telemetry information concerning operation of the resource up to the occurrence of the event.

Processing block 680 discloses receiving a diagnostic event record includes diagnostic telemetry information comprising data about the resource that experienced the event.

Processing block 690 states applying the diagnostic event record to the event framework to identify at least one resource causing the occurrence of the event in the grid-based computing system. The application of the diagnostic event record to the event framework enables the user to drill down and identify the subsystem or resource which caused the occurrence of the event in the grid-based computing system.

Processing block 700 recites presenting, via a graphical user interface, specific identities of resources impacted by the event. The resources may include the resource causing the event or resources which are otherwise impacted by the event.

Processing block 710 discloses executing a diagnostic agent to produce a derived list of suspected failed resources. The diagnostic agent provides a list of suspected failed resources and may further include a probability factor indicating the likelihood of the resource being the cause of the event.

Processing block 720 states executing a diagnostic agent to produce a derived list of suspected failed resources includes suspected failed resources comprising at least one of devices, subsystems, software, hardware and data structures.

Processing block 730 recites collecting information from at least one of the group consisting of accessing utility reports from a selected system, collecting asset survey information for said grid-based computing system, and accessing XML-based delta configuration markup reports from said grid-based computing system.

Processing block 740 states collecting delta reports further comprises collecting differences between at least one of the group consisting of Farm Markup Language (FML) files, Wiring Markup Language (WML) files and Monitoring Markup Language (MML) files.

It is to be understood that embodiments of the invention include the applications (i.e., the un-executed or non-performing logic instructions and/or data) encoded within a computer readable medium such as a floppy disk, hard disk or in an optical medium, or in a memory type system such as in firmware, read only memory (ROM), or, as in this example, as executable code within the memory system (e.g., within random access memory or RAM). It is also to be understood that other embodiments of the invention can provide the applications operating within the processor as the processes. While not shown in this example, those skilled in the art will understand that the computer system may include other processes and/or software and hardware subsystems, such as an operating system, which have been left out of this illustration for ease of description of the invention.

Having described preferred embodiments of the invention it will now become apparent to those of ordinary skill in the art that other embodiments incorporating these concepts may be used. Additionally, the software included as part of the invention may be embodied in a computer program product that includes a computer useable medium. For example, such a computer usable medium can include a readable memory device, such as a hard drive device, a CD-ROM, a DVD-ROM, or a computer diskette, having computer readable program code segments stored thereon. The computer readable medium can also include a communications link, either optical, wired, or wireless, having program code segments carried thereon as digital or analog signals. Accordingly, it is submitted that that the invention should not be limited to the described embodiments but rather should be limited only by the spirit and scope of the appended claims.

1. A method for diagnosing a grid-based computing system, the method comprising:
establishing an event framework defining an arrangement of event information;
receiving a diagnostic event record from a resource within the grid-based computing system, the diagnostic event record containing:
i) event data concerning an event that has occurred within the resource in the grid; and
ii) diagnostic telemetry information concerning operation of the resource up to the occurrence of the event;
applying the diagnostic event record to the event framework to identify at least one resource causing the occurrence of the event in the grid-based computing system; and
presenting, via a graphical user interface, specific identities of resources impacted by the event.

2. The method of claim 1 wherein said establishing an event framework defining an arrangement of event information includes event information comprising a plurality of event types and corresponding event sub-types for each event type and a corresponding severity level for said sub-types.

3. The method of claim 1 wherein said receiving a diagnostic event record includes diagnostic telemetry information comprising data about the resource that experienced the event.

4. The method of claim 1 wherein said establishing an event framework includes a data structure comprising:
a grid event node;
a plurality of event type nodes extending from said grid event node; and
a plurality of sub-event type nodes extending from at least one of said event type nodes.

5. The method of claim 2 wherein said establishing an event framework defining an arrangement of event information includes an event type selected from the group consisting of a grid error report event, a fault event, a chargeable event, and a derived list.

6. The method of claim 2 wherein said establishing an event framework defining an arrangement of event information includes an event sub-type selected from the group consisting of farm level, resource level and control level.

7. The method of claim 2 wherein said establishing an event framework defining an arrangement of event information includes an event severity level selected from the group consisting of critical, non-critical and warning.

8. The method of claim 1 further comprising executing a diagnostic agent to produce a derived list of suspected failed resources.

9. The method of claim 8 wherein said executing a diagnostic agent to produce a derived list of suspected failed resources includes suspected failed resources comprising at least one of devices, subsystems, software, hardware and data structures.

10. The method of claim 1 further comprising collecting information from at least one of the group consisting of accessing utility reports from a selected system, collecting asset survey information for said grid-based computing system, and accessing Extensible Markup Language (XML)-based configuration delta reports from said grid-based computing system.

11. (canceled)

12. A method of diagnosing a grid-based computing system, the method comprising:
establishing an event framework including event information comprising a plurality of event types and corresponding event sub-types for each event type and a corresponding severity level for said sub-types, said event types selected from the group consisting of a grid error report event, a fault event, a chargeable event, and a derived list, said event sub-types selected from the group consisting of farm level, resource level and control level, said severity levels selected from the group consisting of critical, non-critical and warning, said event framework defining an arrangement of event information including a data structure comprising:
a grid event node;
a plurality of event type nodes extending from said grid event node; and
a plurality of sub-event type nodes extending from at least one of said event type nodes;
receiving a diagnostic event record from a resource within the grid-based computing system, the diagnostic event record containing:
i) event data concerning an event that has occurred within the resource in the grid; and
ii) diagnostic telemetry information concerning operation of the resource up to the occurrence of the event;
applying the diagnostic event record to the event framework to identify at least one resource causing the occurrence of the event in the grid-based computing system;
presenting, via a graphical user interface, specific identities of resources impacted by the event;
executing a diagnostic agent to produce a derived list of suspected failed resources comprising at least one of devices, subsystems, software, hardware and data structures; and
collecting information from at least one of the group consisting of accessing utility reports from a selected system, collecting asset survey information for said grid-based computing system, and accessing delta reports from said grid-based computing system, said collecting delta reports further comprising collecting differences between at least one of the group consisting of Farm Markup Language (FML) files, Wiring Markup Language (WML) files and Monitoring Markup Language (MML) files.

13. A physical computer readable medium having computer readable code thereon for remotely diagnosing grid-based computing systems, the medium comprising:
instructions for establishing an event framework defining an arrangement of event information;
instructions for receiving a diagnostic event record from a resource within the grid-based computing system, the diagnostic event record containing:
i) event data concerning an event that has occurred within the resource in the grid; and
ii) diagnostic telemetry information concerning operation of the resource up to the occurrence of the event;
instructions for applying the diagnostic event record to the event framework to identify at least one resource causing the occurrence of the event in the grid-based computing system; and
instructions for presenting, via a graphical user interface, specific identities of resources impacted by the event.

14. The medium of claim 13 wherein said instructions for establishing an event framework defining an arrangement of event information further comprises instructions defining a plurality of event types and corresponding event sub-types for each event type and a corresponding severity level for said sub-types.

15. The medium of claim 13 wherein said instructions for receiving a diagnostic event record include instructions for receiving diagnostic telemetry information including data about the resource that experienced the event.

16. The medium of claim 13 wherein said instructions for establishing an event framework include instructions for establishing a framework comprising:
a grid event node;
a plurality of event type nodes extending from said grid event node; and
a plurality of sub-event type nodes extending from at least one of said event type nodes.

17. The medium of claim 14 wherein said instructions defining a plurality of event types include instructions defining an event type selected from the group consisting of a grid error report event, a fault event, a chargeable event, and a derived list.

18. The medium of claim 14 wherein said instructions defining a plurality of event sub-types include instructions defining an event sub-type selected from the group consisting of farm level, resource level and control level.

19. The medium of claim 14 wherein said instructions defining a plurality of event severity levels include instructions defining severity level selected from the group consisting of critical, non-critical and warning.

20. The medium of claim 13 further comprising instructions for executing a diagnostic agent to produce a derived list of suspected failed resources.

21. The medium of claim 20 wherein said instructions for executing a diagnostic agent to produce a derived list of suspected failed resources includes instructions for producing a derived list of suspected failed resources including at least one of devices, subsystems, software, hardware and data structures.

22. The medium of claim 13 further comprising instructions for collecting information from at least one of the group consisting of accessing utility reports from a selected system, collecting asset survey information for said grid-based computing system, and accessing delta reports from said grid-based computing system.

23. (canceled)

24. A physical computer readable medium having computer readable code thereon for remotely diagnosing grid-based computing systems, the medium comprising:
instructions for establishing an event framework including event information comprising a plurality of event types and corresponding event sub-types for each event type and a corresponding severity level for said sub-types, said event types selected from the group consisting of a grid error report event, a fault event, a chargeable event, and a derived list, said event sub-types selected from the group consisting of farm level, resource level and control level, said severity levels selected from the group consisting of critical, non-critical and warning, said event framework defining an arrangement of event information including a data structure comprising:
a grid event node;
a plurality of event type nodes extending from said grid event node; and
a plurality of sub-event type nodes extending from at least one of said event type nodes;
instructions for receiving a diagnostic event record from a resource within the grid-based computing system, the diagnostic event record containing:
i) event data concerning an event that has occurred within the resource in the grid; and
ii) diagnostic telemetry information concerning operation of the resource up to the occurrence of the event;
instructions for applying the diagnostic event record to the event framework to identify at least one resource causing the occurrence of the event in the grid-based computing system;
instructions for presenting, via a graphical user interface, specific identities of resources impacted by the event;
instructions for executing a diagnostic agent to produce a derived list of suspected failed resources comprising at least one of devices, subsystems, software, hardware and data structures; and
instructions for collecting information from at least one of the group consisting of accessing utility reports from a selected system, collecting asset survey information for said grid-based computing system, and accessing delta reports from said grid-based computing system, said collecting delta reports further comprising collecting differences between at least one of the group consisting of Farm Markup Language (FML) files, Wiring Markup Language (WML) files and Monitoring Markup Language (MML) files.

25. A computer system comprising:
a memory;
a processor;
a communications interface;
an interconnection mechanism coupling the memory, the processor and the communications interface; and
wherein the memory is encoded with an application that when performed on the processor, provides a process for processing information, the process causing the computer system to perform the operations of:
establishing an event framework defining an arrangement of event information;
receiving a diagnostic event record from a resource within the grid-based computing system, the diagnostic event record containing:
i) event data concerning an event that has occurred within the resource in the grid; and
ii) diagnostic telemetry information concerning operation of the resource up to the occurrence of the event;
applying the diagnostic event record to the event framework to identify at least one resource causing the occurrence of the event in the grid-based computing system; and
presenting, via a graphical user interface, specific identities of resources impacted by the event.

26. The computer system of claim 25 wherein said event information comprises a plurality of event types and corresponding event sub-types for each event type and a corresponding severity level for said sub-types.

27. The computer system of claim 25 wherein said diagnostic telemetry information comprises data about the resource that experienced the event.

28. The computer system of claim 25 wherein said event framework comprises a data structure, the data structure comprising:
a grid event node;
a plurality of event type nodes extending from said grid event node; and
a plurality of sub-event type nodes extending from at least one of said event type nodes.

29. The computer system of claim 26 wherein said event type is selected from the group consisting of a grid error report event, a fault event, a chargeable event, and a derived list.

30. The computer system of claim 26 wherein said event sub-type is selected from the group consisting of farm level, resource level and control level.

31. The computer system of claim 26 wherein said severity level is selected from the group consisting of critical, non-critical and warning.

32. The computer system of claim 25 further comprising executing a diagnostic agent to produce a derived list of suspected failed resources.

33. The computer system of claim 32 wherein said suspected failed resources include at least one of devices, subsystems, software, hardware and data structures.

34. The computer system of claim 25 further comprising at least one of the group consisting of accessing utility reports from a selected system, collecting asset survey information for said grid-based computing system, and accessing delta reports from said grid-based computing system.

35. (canceled)

36. A computer system comprising:
a memory;
a processor;
a communications interface;
an interconnection mechanism coupling the memory, the processor and the communications interface; and
wherein the memory is encoded with an application that when performed on the processor, provides a process for processing information, the process causing the computer system to perform the operations of:
establishing an event framework including event information comprising a plurality of event types and corresponding event sub-types for each event type and a corresponding severity level for said sub-types, said event types selected from the group consisting of a grid error report event, a fault event, a chargeable event, and a derived list, said event sub-types selected from the group consisting of farm level, resource level and control level, said severity levels selected from the group consisting of critical, non-critical and warning, said event framework defining an arrangement of event information including a data structure comprising:
a grid event node;
a plurality of event type nodes extending from said grid event node; and
a plurality of sub-event type nodes extending from at least one of said event type nodes;
receiving a diagnostic event record from a resource within the grid-based computing system, the diagnostic event record containing:
i) event data concerning an event that has occurred within the resource in the grid; and
ii) diagnostic telemetry information concerning operation of the resource up to the occurrence of the event;
applying the diagnostic event record to the event framework to identify at least one resource causing the occurrence of the event in the grid-based computing system;
presenting, via a graphical user interface, specific identities of resources impacted by the event;
executing a diagnostic agent to produce a derived list of suspected failed resources comprising at least one of devices, subsystems, software, hardware and data structures; and
collecting information from at least one of the group consisting of accessing utility reports from a selected system, collecting asset survey information for said grid-based computing system, and accessing delta reports from said grid-based computing system, said collecting delta reports further comprising collecting differences between at least one of the group consisting of Farm Markup Language (FML) files, Wiring Markup Language (WML) files and Monitoring Markup Language (MML) files.

37. The method of claim 1 wherein said grid-based computing system is formed from computing resources belonging to multiple individuals or organizations.

38. The computer readable medium of claim 13 wherein said grid-based computing system is formed from computing resources belonging to multiple individuals or organizations.

39. The computer system of claim 25 wherein said grid-based computing system is formed from computing resources belonging to multiple individuals or organizations.
